(19) United States
(12) Patent Application Publication
(10) Pub. No.: US 2025/0208309 A1
(43) Pub. Date: Jun. 26, 2025

(54) SEISMIC EXPLORATION METHOD, SUBSURFACE MONITORING METHOD, SEISMIC EXPLORATION SYSTEM, AND SEISMIC SOURCE DEVICE

(71) Applicant: THE UNIVERSITY OF TOKYO, Tokyo (JP)

(72) Inventor: Takeshi TSUJI, Tokyo (JP)

(21) Appl. No.: 19/074,887

(22) Filed: Mar. 10, 2025

Related U.S. Application Data
(63) Continuation of application No. PCT/JP2023/032924, filed on Sep. 8, 2023.

(30) Foreign Application Priority Data
Sep. 9, 2022 (JP) 2022-143876

(51) Int. Cl. G01V 1/153; G01V 1/047; G01V 8/16

(52) U.S. Cl. CPC G01V 1/153; G01V 1/047; G01V 8/16; G01V 2210/1214; G01V 2210/1299; G01V 2210/1429

(57) ABSTRACT

A seismic exploration method includes: causing a seismic source device disposed in a subsurface to generate a vibration; and acquiring, by a signal acquisition device, a vibration signal based on the vibration generated by the seismic source device. The seismic source device includes rotating bodies that are eccentric, and each rotates about a rotation shaft, and a drive unit that generates vibration by rotating the rotating bodies.

### CROSS REFERENCE TO RELATED APPLICATIONS

This application is a continuation under 35 U.S.C. § 120 of PCT/JP2023/032924, filed Sep. 8, 2023, which is incorporated herein by reference, and which claimed priority to Japan Application No. 2022-143876, filed Sep. 9, 2022. The present application likewise claims priority under 35 U.S.C. § 119 to Japanese Application No. 2022-143876, filed Sep. 9, 2022, the entire content of which is also incorporated herein by reference.

### BACKGROUND

### 1. Technical Field

The present disclosure relates to a seismic exploration method, a subsurface monitoring method, a seismic exploration system, and a seismic source device.

### 2. Description of the Related Art

Conventionally, exploration of a geological structure has been performed by observing propagation of an artificially generated seismic wave. For example, Patent Literature 1 (JP H10-142344 A) describes a rotating seismic source device in which rotation shafts of a pair of eccentric rotors having the same amount of eccentricity are axially supported in parallel, and the two eccentric rotors are driven at the same rotation speed in opposite directions with their phases aligned in a manner that one of the eccentric portions of the two eccentric rotors is symmetrical to the other, thereby continuously generating a seismic wave reciprocating in one axial direction.

However, the inventor of the present application has recognized the following problems. That is, when the rotating seismic source device is installed on a ground surface, the seismic wave is affected by the environment on the ground surface, and the accuracy of the exploration of the geological structure is reduced. Therefore, the technique described in Patent Literature 1 using the rotating seismic source device installed on the ground surface cannot accurately monitor the subsurface.

### SUMMARY

The present disclosure has been made in view of such a situation, and an exemplary object thereof is to provide a technique that enables more accurate subsurface monitoring.

One aspect of the present disclosure is a seismic exploration method. The seismic exploration method includes: causing a seismic source device disposed in a subsurface to generate a vibration; and acquiring, by a signal acquisition device, a vibration signal based on the vibration generated by the seismic source device. The seismic source device includes a rotating body that is eccentric and rotates about a rotation shaft, and a drive unit that generates vibration by rotating the rotating body.

Another aspect of the present disclosure is a subsurface monitoring method. The subsurface monitoring method includes the seismic exploration method.

Another aspect of the disclosure is a seismic exploration system. A seismic exploration system includes: a seismic source device that is disposed in a subsurface and generates vibration; and a signal acquisition device that acquires a vibration signal based on the vibration generated by the seismic source device. The seismic source device includes a rotating body that is eccentric and rotates about a rotation shaft, and a drive unit that generates vibration by rotating the rotating body.

Another aspect of the present disclosure is a seismic source device. The seismic source device includes: a seismic source portion that includes a rotating body which is eccentric and rotates about a rotation shaft, and a drive unit that generates vibration by rotating the rotating body; and a housing portion that houses the seismic source portion in an internal space. The housing portion houses the seismic source portion in a manner that the seismic source portion can be detached through an opening of the internal space.

It is to be noted that any arbitrary combination or rearrangement of the above-described structural components and so forth is effective as and encompassed by the present embodiments. Moreover, this summary does not necessarily describe all necessary features so that the disclosure may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic configuration diagram of a seismic exploration system according to a first embodiment;

FIG. 2 is a functional block diagram of a management device according to the first embodiment;

FIG. 3 is a diagram illustrating a schematic configuration of the seismic exploration system according to the first embodiment and a subsurface cross section thereof;

FIG. 4 is a diagram illustrating a schematic configuration of a seismic source unit according to the first embodiment;

FIG. 5 is a schematic cross-sectional view of a seismic source portion according to the first embodiment;

FIG. 6 is a flowchart illustrating an operation example of the seismic exploration system according to the first embodiment;

FIG. 7 is a diagram illustrating a schematic configuration of a seismic exploration system according to a second embodiment and a subsurface cross section thereof;

FIG. 8 is a diagram illustrating a schematic configuration of a seismic exploration system according to a third embodiment and a subsurface cross section thereof;

FIG. 9 is a diagram illustrating a schematic configuration of a seismic exploration system according to a fourth embodiment and a subsurface cross section thereof;

FIG. 10 is a functional block diagram of a laser device according to the fourth embodiment;

FIG. 11 is a diagram illustrating a schematic configuration of a seismic source unit according to a fifth embodiment;

FIG. 12 is a cross-sectional view illustrating a schematic configuration of a seismic source portion according to a sixth embodiment;

FIG. 13 is a cross-sectional view illustrating a schematic configuration of a seismic source portion according to a seventh embodiment;

FIG. 14 is a diagram schematically illustrating a seismic source portion according to an eighth embodiment;

FIG. 15 is a perspective view of a seismic source unit according to a ninth embodiment.

### DETAILED DESCRIPTION

### Background

In recent years, carbon capture and storage (CCS), which is a technique for processing carbon dioxide as a greenhouse gas in a subsurface, has attracted attention as a practical means. In CCS, carbon dioxide is injected into the subsurface using a well (hereinafter also referred to as “injection well”) for sending carbon dioxide from a ground surface to the subsurface, and the carbon dioxide is stored in the subsurface.

The International Energy Agency (IEA) has proposed a 15% reduction in carbon dioxide emissions in 2020. However, it is considered that this target of 15% reduction is a very high target, and in order to realize this with CCS, large-scale sites (hereinafter also referred to as “CO2 storage sites”) for storing carbon dioxide in thousands of places in the world are required, and the number of injection wells required in Japan is about 240 to 480.

In order to ensure safety, it is necessary to monitor the CO2 storage sites, but a realistic method for realizing that has not been established. In view of such a situation, the inventor of the present application has conceived a seismic exploration system capable of continuously monitoring CO2 storage sites as described in the following embodiments.

### EMBODIMENTS

Hereinafter, embodiments of the present disclosure will be described in detail with reference to the drawings. In the description of the drawings, the same components are denoted by the same reference signs, and redundant description will be omitted as appropriate. The configuration described below is an example and does not limit the scope of the present invention at all.

In addition, in the present description and the drawings, a plurality of components having substantially the same functional configuration may be distinguished by attaching different alphabets after the same reference sign. Here, in a case where it is not necessary to particularly distinguish each of the plurality of components having substantially the same functional configuration, only the same reference sign is attached to each of the plurality of components. In the description of the drawings, the same components are denoted by the same reference signs, and redundant description will be omitted as appropriate. For example, when a coupling mechanism 140a and a coupling mechanism 140b are not particularly distinguished, they are simply referred to as “coupling mechanism 140”.

### First Embodiment

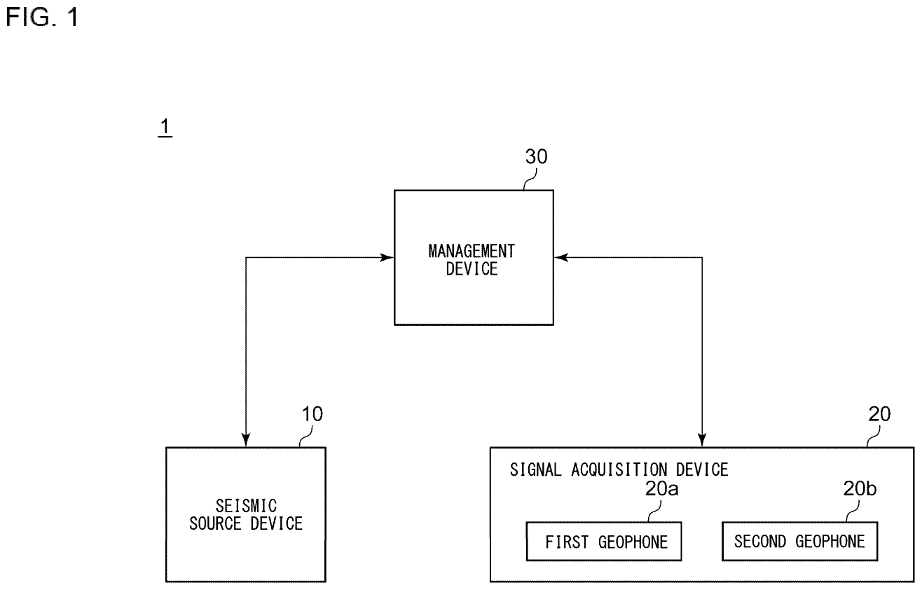

FIG. 1 is a schematic configuration diagram of a seismic exploration system 1 according to a first embodiment. As illustrated in FIG. 1, the seismic exploration system 1 according to the present embodiment includes a seismic source device 10, a signal acquisition device 20, and a management device 30. The seismic exploration system 1 according to the present embodiment performs subsurface monitoring based on seismic exploration. Specifically, the seismic exploration system 1 performs the investigation of the geological structure by seismic exploration a plurality of times at regular intervals. When there is a change in the subsurface state at an interval of the investigation, the seismic exploration system 1 can grasp the change as a difference in the result of the seismic exploration.

The seismic source device 10 according to the present embodiment is disposed in a hole formed in the subsurface and generates vibration inside the hole. The seismic source device 10 generates vibration of a waveform (chirp) including a wide range of frequency, and the management device 30 performs cross-coherence analysis on an oscillation waveform recorded by a first geophone 20a (described later) installed near the seismic source device 10 and a waveform recorded by a second geophone 20b (described later) installed at a position away from the seismic source device 10. Thus, it is possible to obtain a result equivalent to that of a case where an impulse seismic source is oscillated at the seismic source device 10 and waveform is recorded by the second geophone 20b. The seismic source device 10 according to the present embodiment generates vibration by rotating a rotating body which is eccentric and rotates about a rotation shaft. Note that the seismic source device 10 may be structured to drive a piston into a hole formed in the subsurface and generate vibration in the subsurface by the impact.

The signal acquisition device 20 acquires a vibration signal based on the vibration generated by the seismic source device 10 and transmits the vibration signal to the management device 30. The signal acquisition device 20 may include various known seismometers, and specifically, may include a geophone or the like. In the present embodiment, the signal acquisition device 20 includes the first geophone 20a installed near the seismic source device 10 and the second geophone 20b installed at a position farther from the seismic source device 10 than the first geophone 20a. The first geophone 20a acquires a first vibration signal based on the vibration generated by the seismic source device 10, and transmits the first vibration signal to the management device 30. The second geophone 20b acquires the second vibration signal based on the vibration generated by the seismic source device 10, and transmits the second vibration signal to the management device 30.

The management device 30 manages the operation of the seismic exploration system 1. Specifically, the management device 30 controls the operation of the seismic source device 10, instructs the signal acquisition device 20 to acquire the vibration signal, and performs various types of processing based on the detection result of the signal acquisition device 20. For example, the management device 30 can supply power to the seismic source device 10 and cause the seismic source device 10 to generate vibration. In addition, the management device 30 can transmit a trigger signal instructing recording of a vibration signal to the geophone, record the vibration signal together with time information, and analyze the geology using the vibration signal from the signal acquisition device 20. The management device 30 may include a central processing unit (CPU), a read access memory (RAM), a read only memory (ROM), and the like. In addition, the management device 30 may include a global positioning system (GPS) for recording accurate time.

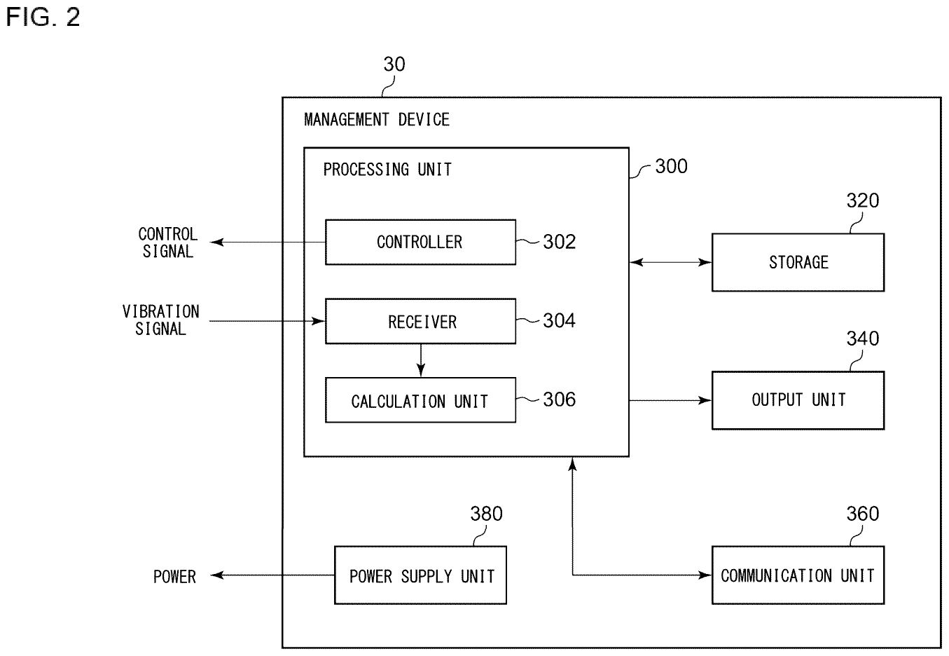

FIG. 2 is a functional block diagram of the management device 30 according to the first embodiment. As illustrated in FIG. 2, the management device 30 according to the present embodiment includes a processing unit 300, a storage 320, an output unit 340, a communication unit 360, and a power supply unit 380.

The processing unit 300 performs various types of processing, specifically, transmits a control signal to the seismic source device 10, receives a vibration signal from the signal acquisition device 20, and performs arithmetic processing using the vibration signal. The functions of the processing unit 300 are implemented by a controller 302, a receiver 304, and a calculation unit 306. Note that the controller 302, the receiver 304, and the calculation unit 306 may be separately prepared.

The controller 302 transmits a control signal to the seismic source device 10 and controls the operation of the seismic source device 10. Specifically, the controller 302 may control the operation conditions (for example, rotation speed or the like) of the motor of the seismic source device 10.

The receiver 304 receives the vibration signal from the signal acquisition device 20 and transmits the vibration signal to the calculation unit 306. The calculation unit 306 performs various types of calculation processing based on the vibration signal, and transmits the results to the storage 320 and the output unit 340. For example, the calculation unit 306 may perform processing related to geology analysis based on the vibration signal.

The calculation unit 306 according to the present embodiment analyzes the vibration signals (the first vibration signal and the second vibration signal) acquired by the two geophones (the first geophone 20a and the second geophone 20b). Specifically, the calculation unit 306 synchronizes the first vibration signal and the second vibration signal, and analyzes the geology using various known analysis techniques based on these synchronized vibration signals.

More specifically, the calculation unit 306 uses the first vibration signal as the original function, and acquires the original signal for analyzing the geology based on the first vibration signal and the second vibration signal using the cross-coherence method (see the references below). The calculation unit 306 can analyze the geology using the original signal.

(References) Nakata, N., Snieder, R., Tsuji, T., Larner, K., Matsuoka, T. (2011). Shear wave imaging from traffic noise using seismic interferometry by cross-coherence. Geophysics, 76:SA97-SA106. https://doi.org/10.1190/geo2010-0188.1

The storage 320 stores various types of information. For example, the storage 320 may store a control program for the controller 302 to control the seismic source device 10, a calculation program for the calculation unit 306 to perform various calculations, a calculation result of the calculation unit 306, and the like.

The output unit 340 outputs various types of information. The output unit 340 may include various known display devices or audio output devices. For example, the output unit 340 may display the calculation result of the calculation unit 306. Specifically, the output unit 340 may display an image for monitoring the CO2 storage sites.

The communication unit 360 is a communication interface for transmitting and receiving various types of information to and from other devices. For example, the communication unit 360 may transmit the analysis result by the calculation unit 306 to other devices. Furthermore, the communication unit 360 may be used when remotely controlling a device.

The power supply unit 380 supplies power to the seismic source device 10. For example, the power supply unit 380 may convert power from a commercial power source (not illustrated) as necessary and supply the power to the seismic source device 10. Note that the power supply unit 380 may supply power for the management device 30. Further, in the case of a small seismic source device, a 12 V DC battery may be used. In this case, power may be supplied from a solar panel.

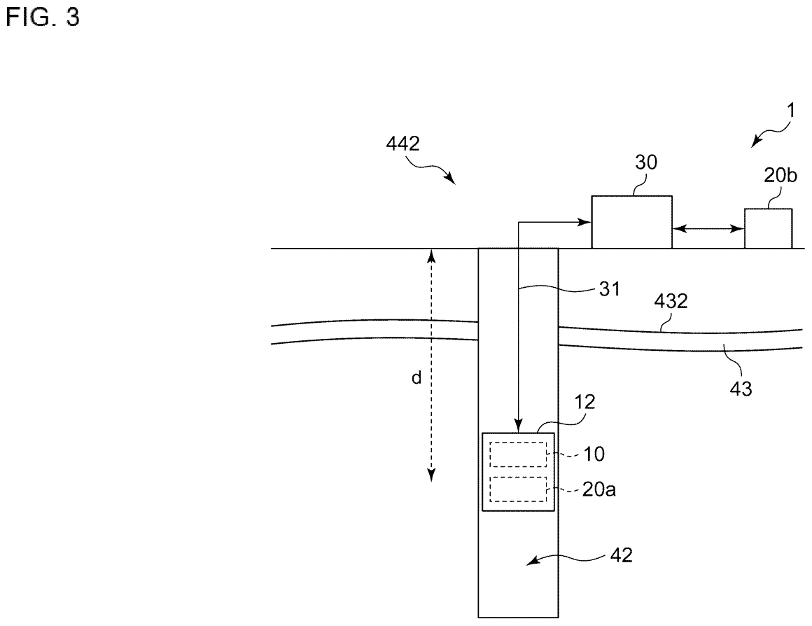

FIG. 3 is a diagram illustrating a schematic configuration of the seismic exploration system 1 according to the first embodiment and a subsurface cross section thereof. The seismic exploration system 1 according to the present embodiment includes a seismic source unit 12 disposed in the subsurface, the geophone 20b (second geophone) disposed on a ground surface 422, and the management device 30.

The seismic source unit 12 according to the present embodiment includes the seismic source device 10 and the geophone 20a (first geophone). The seismic source device 10 of the seismic source unit 12 can generate vibration in accordance with the control by the management device 30. The geophone 20a acquires the first vibration signal based on the vibration generated by the seismic source device 10 and transmits the acquired first vibration signal to the management device 30.

In the present embodiment, a hole 42 (also referred to as “well”) extending in the vertical direction is formed in the subsurface. The seismic source unit 12 according to the present embodiment is disposed inside the hole 42, and the seismic source unit 12 can be taken out from the hole 42 or inserted into the hole 42 as necessary. A depth d of the position where the seismic source unit 12 is disposed in the hole 42 is not particularly limited, and may be, for example, a depth of about 100 m or 1000 m. Further, the seismic source unit may be installed at a plurality of locations with different depths to perform the oscillation operation. Further, if the seismic source unit can be installed near the monitoring target, the acquisition of more accurate data can be expected.

In the present embodiment, an aquifer 43 which is a geological layer filled with groundwater is formed in the subsurface. The hole 42 according to the present embodiment is formed in a manner of penetrating the aquifer 43. Therefore, groundwater from the aquifer 43 is accumulated in the hole 42.

The seismic source unit 12 may be disposed at a position deeper than the aquifer 43. In a case where the seismic source unit 12 is at a position higher than the aquifer 43 and the seismic source unit 12 is at a position higher than the water surface at a normal time, the water level of the groundwater accumulated in the hole 42 may change due to rainfall or the like, and the operation (for example, vibration to be generated) by the seismic source unit 12 may be affected by the change of the groundwater, and thus, the monitoring accuracy may be deteriorated. On the other hand, by arranging the seismic source unit 12 at a position deeper than the groundwater level (for example, a water surface 432 of the aquifer 43 illustrated in FIG. 3) as in the present embodiment, the seismic source unit 12 sinks in the groundwater regardless of the change in the water level of the groundwater due to rainfall or the like, and thus, it is possible to suppress the affect on monitoring due to the change in the water level of the groundwater.

The geophone 20b acquires the second vibration signal based on the vibration generated by the seismic source unit 12 and transmits the acquired second vibration signal to the management device 30. The management device 30 according to the present embodiment can analyze, for example, the geology or the like based on the vibration signals including the first vibration signal and the second vibration signal transmitted from the geophone 20a and the geophone 20b. In addition, a change occurring in the subsurface can be monitored from a temporal change of the vibration signal. In the present embodiment, the number of the geophone 20b is one, but it is preferable to install a plurality of (for example, 100) geophones. In particular, a plurality of geophones is required in the case of performing reflection seismic exploration, refraction seismic exploration, or surface wave seismic exploration.

FIG. 3 illustrates an example in which the seismic exploration system 1 includes one seismic source unit 12 which is disposed in one hole 42. The disclosure is not limited thereto, and a plurality of holes may be formed. In this case, the seismic exploration system 1 may have a plurality of seismic source units disposed respectively in the plurality of holes. This makes it possible to generate vibrations at more locations and to analyze the geology of a wider area or to monitor the subsurface.

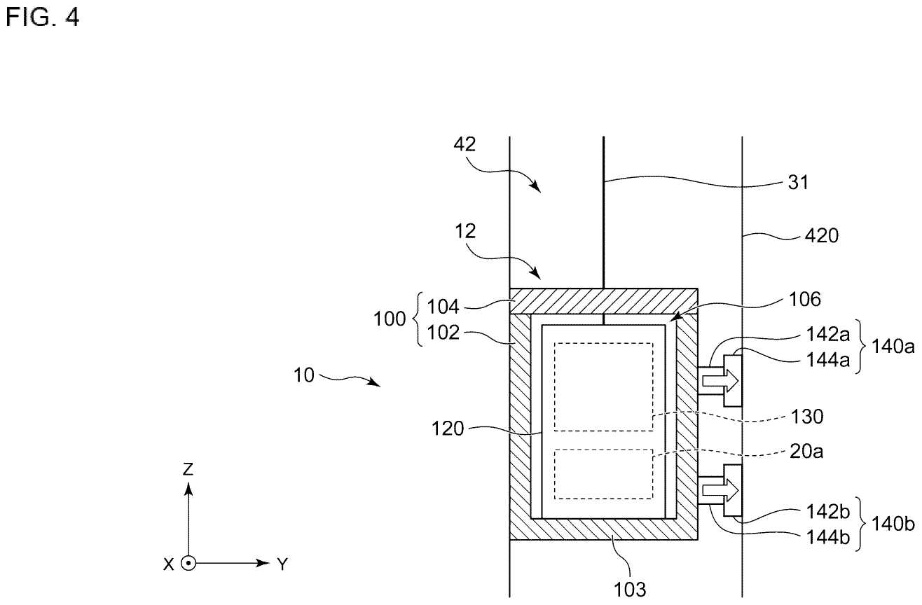

FIG. 4 is a diagram illustrating a schematic configuration of the seismic source unit 12 according to the first embodiment. A Z axis indicates the vertical direction, and an X axis and a Y axis indicate the horizontal directions, respectively. The X axis is a direction perpendicular to the Z axis, and the Y axis is a direction perpendicular to the Z axis and the X axis.

The seismic source device 10 according to the present embodiment mainly includes a housing portion 100, a support 120, a seismic source portion 130, and coupling mechanisms 140a and 140b.

The housing portion 100 houses the support 120, the seismic source portion 130, and the geophone 20b. The housing portion 100 may be formed of a pressure-resistant container, and may be made of metal or the like, for example. The housing portion 100 has a cylindrical shape, and may have a size of, for example, about 10 cm in length and about 10 cm in diameter. The housing portion 100 includes a housing 102 and a lid portion 104, and an internal space 106 surrounded by the housing 102 and the lid portion 104 is formed therein.

The housing 102 has a hollow cylindrical shape extending in the Z-axis direction, one lower end of the housing 102 is closed by a bottom portion 103 which forms a part of the housing 102, and one upper end of the housing 102 is closed by the lid portion 104.

The lid portion 104 is fixed to the housing 102 in a manner of being capable of opening and closing an upper opening of the housing 102. When the lid portion 104 is closed, the inside of the housing portion 100 is sealed, and the groundwater accumulated in the hole 42 does not enter the internal space 106. When the lid portion 104 is opened, the support 120 can be taken out from the housing 102.

Various sensors which are not illustrated may be disposed in the housing portion 100. For example, a temperature sensor, a water pressure sensor, and the like may be disposed. These sensors may be disposed in a manner of being connected to the management device 30 and being capable of transmitting measurement results regarding temperature, water pressure, and the like to the management device 30.

The support 120 has a hollow cylindrical shape extending in the Z-axis direction and supports the seismic source portion 130 and the geophone 20b therein. The support 120 is detachably fixed to the housing 102 of the housing portion 100. The support 120 may be directly fixed to the housing 102 or may be fixed to the housing 102 via a fixing tool. Note that FIG. 4 is drawn in a manner that a gap exists between the housing portion 100 and the support 120 in the internal space 106, but there may be no gap between the housing portion 100 and the support 120. For example, it is preferable that the support 120 is fixed in close contact with the housing 102.

The seismic source portion 130 generates vibration used for seismic exploration. The seismic source portion 130 according to the present embodiment includes a motor (drive unit) and an eccentric rotating body, and the motor rotates the rotating body to generate vibration. A cable 31 connected to the management device 30 is connected to the seismic source portion 130. Through the cable 31, the management device 30 supplies power and transmits a control signal to the motor of the seismic source portion 130. Thus, the seismic source portion 130 can generate vibration.

The first vibration signal based on the vibration generated by the seismic source portion 130 is acquired by the geophone 20a installed inside the housing portion 100. The vibration generated by the seismic source portion 130 is transmitted to the periphery of the hole 42 through the side surface of the housing portion 100 or the coupling mechanisms 140a and 140b. The second vibration signal based on this vibration is acquired by, for example, the geophone 20b disposed on the ground surface. Note that the first vibration signal based on the vibration of the seismic source portion 130 may be recorded by a geophone installed inside the housing portion 100.

The condition of the vibration generated by the seismic source portion 130 can be adjusted by replacing various parts of the seismic source portion 130. For example, the condition of the vibration can be adjusted by changing, for example, a motor included in seismic source portion 130, a gear for transmitting a driving force of the motor to the rotating body, a weight of a counterweight, which is to be described later, for causing the rotating body to be eccentric.

When the parts of the seismic source portion 130 are replaced, first, the seismic source unit 12 is taken out from the hole 42 to the ground surface. Thereafter, the lid portion 104 is opened, and for example, a fixture for fixing the support 120 and the housing 102 is released to take the support 120 out of the housing 102. Thereafter, the condition of the vibration generated by the seismic source portion 130 can be adjusted by replacing the parts of the seismic source portion 130. By disposing the seismic source unit 12 in the hole 42 again after replacing the parts, it is possible to generate vibration under a new condition in the seismic source portion 130.

The coupling mechanisms 140a and 140b couple the housing 102 of the housing portion 100 with an inner peripheral surface 420 of the hole 42. The coupling mechanism 140a and the coupling mechanism 140b have substantially the same configuration.

The coupling mechanism 140 includes a pressing portion 142 and a coupling portion 144. The pressing portion 142 has one end connected to the housing 102, extends in a direction away from the housing 102, and has the other end connected to the coupling portion 144. The pressing portion 142 is structured to be capable of pressing the coupling portion 144 against the inner peripheral surface 420 of the hole 42. Specifically, the pressing portion 142 is structured to be capable of expanding and contracting in the horizontal direction (for example, the Y-axis direction), and presses the coupling portion 144 by extending in a direction indicated by an arrow in FIG. 4. The configuration for pressing the coupling portion 144 by the pressing portion 142 is not particularly limited, and may be, for example, a hydraulic type or an electrically controlled type. In a case where the pressing portion 142 has an electrically controlled pressing mechanism, the strength of the force by which the pressing mechanism presses the coupling portion 144 may be adjusted by the management device 30 controlling the pressing mechanism.

When the pressing portions 142a and 142b press the coupling portions 144a and 144b against the inner peripheral surface 420 of the hole 42, respectively, the housing portion 100 is coupled to the inner peripheral surface 420 of the hole 42. Thus, the vibration generated by the seismic source portion 130 is more reliably transmitted to the surroundings via the housing portion 100, the coupling mechanism 140, and the inner peripheral surface 420 of the hole 42.

Note that, although the example in which the two coupling mechanisms 140a and 140b are provided in the housing 102 has been described here, the number of coupling mechanisms may be one or three or more. Although the example in which the coupling mechanism couples the housing portion 100 to the inner peripheral surface 420 in one direction (Y-axis direction) has been described, the present disclosure is not limited thereto, and a plurality of coupling mechanisms may be provided in a manner that the housing portion 100 is coupled to the inner peripheral surface 420 in a plurality of directions different from each other. For example, a plurality of coupling mechanisms may be provided side by side in the circumferential direction on the outer peripheral surface of the housing 102, and the housing portion 100 may be coupled in a plurality of directions.

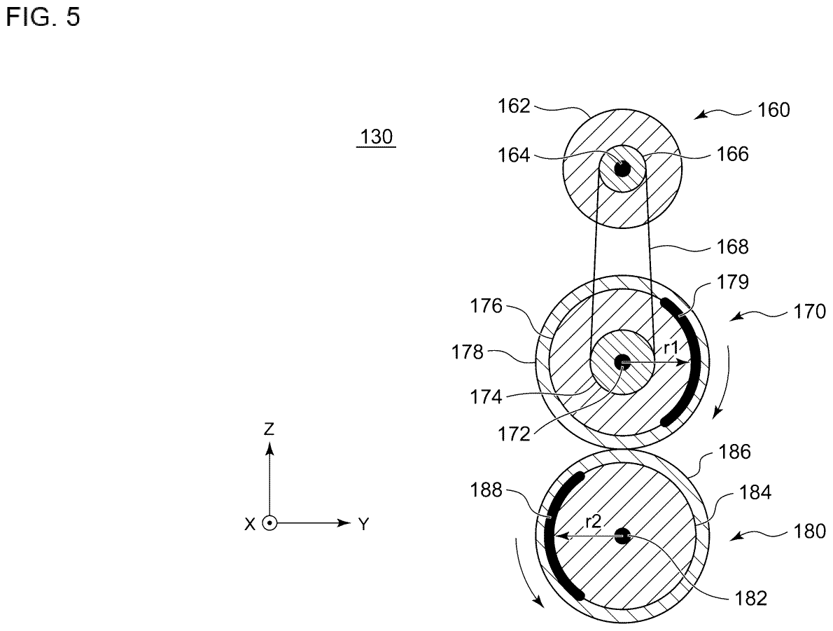

FIG. 5 is a schematic cross-sectional view of the seismic source portion 130 according to the first embodiment. As illustrated in FIG. 5, the seismic source portion 130 according to the present embodiment includes a motor 160 (drive unit), a first rotating body 170, and a second rotating body 180.

The motor 160 is driven in accordance with the control by the management device 30 and transmits the driving force to the first rotating body 170. The motor 160 according to the present embodiment includes a main body 162, a rotation shaft 164, and a transmitter 166. A part of the rotation shaft 164 is housed in the main body 162. The rotation shaft 164 extends in the X-axis direction and is structured to be rotatable about the length direction thereof. The transmitter 166 has a cylindrical shape extending in the X-axis direction, is disposed in a manner of covering the rotation shaft 164, and is structured to be rotatable integrally with the rotation shaft 172.

The motor 160 may be provided with a speed sensor (not illustrated). The speed sensor may be connected to the management device 30, measure the rotation speed of the rotation shaft 164, and transmit the measurement result to the management device 30.

The first rotating body 170 includes a rotation shaft 172, a transmission target 174, a counterweight support 176, a gear 178, and a counterweight 179. The rotation shaft 172 extends in the X-axis direction and is structured to be rotatable about the length direction thereof. The transmission target 174 has a cylindrical shape extending in the X-axis direction, is disposed in a manner of covering the rotation shaft 172, and is structured to be rotatable integrally with the rotation shaft 172. In addition, a belt 168 is provided around the transmitter 166 and around the transmission target 174.

The disk-shaped counterweight support 176 is provided around the transmission target 174 and is structured to be rotatable integrally with the transmission target 174. The disk-shaped gear 178 is provided around the counterweight support 176 and is structured to be rotatable integrally with the counterweight support 176. The counterweight 179 is provided on a part of the circumference of the counterweight support 176. Due to the counterweight 179, the first rotating body 170 is eccentrically positioned relative to the center thereof (the position of the rotation shaft 172 on the YZ plane) toward the center of the counterweight 179. In the state illustrated in FIG. 5, the first rotating body 170 is eccentrically positioned at a distance of r1 in the Y-axis direction from its center.

The second rotating body 180 includes a rotation shaft 182, a counterweight support 184, a gear 186, and a counterweight 188. The rotation shaft 182 extends in the X-axis direction and is structured to be rotatable about the length direction thereof. The disk-shaped counterweight support 184 is provided around the rotation shaft 182 and is structured to be rotatable integrally with the rotation shaft 182. The disk-shaped gear 186 is provided around the counterweight support 184 and is structured to be rotatable integrally with the counterweight support 184. The gear 186 is disposed in a manner of being fitted to the gear 178.

The counterweight 188 is provided on a part of the circumference of the counterweight support 184. Due to the counterweight 188, the second rotating body 180 is eccentrically positioned relative to the center thereof (the position of the rotation shaft 182 on the YZ plane) toward the center of the counterweight 188. In the state illustrated in FIG. 5, the second rotating body 180 is eccentrically positioned at a distance of r2 in the direction opposite to the Y-axis direction from its center.

In the present embodiment, the mass of the counterweight 179 and the mass of the counterweight 188 are equal to each other at m1. In addition, the counterweight 179 and the counterweight 188 are disposed on the first rotating body 170 and the second rotating body 180 in a manner that the amounts of eccentricity are equal to each other. That is, the counterweight 179 and the counterweight 188 are disposed in a manner that m1×r1=m1×r2.

When the motor 160 is driven, the rotation shaft 164 rotates, and with this rotation, the transmitter 166 rotates together with the rotation shaft 164. At this time, the driving force is transmitted from the transmitter 166 to the transmission target 174 via the belt 168. Thus, the transmission target 174 rotates in the clockwise direction about the rotation shaft 172 together with the other members forming the first rotating body 170. At this time, the gear 186 of the second rotating body 180 receives a driving force from the gear 178 of the first rotating body 170. Thus, the gear 186 rotates about the rotation shaft 182 in a direction opposite to the rotation direction of the first rotating body 170 (counterclockwise direction) together with the other members forming the second rotating body 180.

Focusing on the operations of the counterweight 179 and the counterweight 188 during the rotation of the first rotating body 170 and the second rotating body 180, the components in the horizontal direction (for example, the Y-axis direction) of the rotation speeds of the counterweights 179 and 188 cancel out each other, and the components in the vertical direction (the Z-axis direction) of the rotation speeds of the counterweights 179 and 188 intensify each other. Therefore, the seismic source portion 130 can generate vibration in the vertical direction through rotating the first rotating body 170 and the second rotating body 180 by driving the motor 160.

The seismic source portion 130 according to the present embodiment continuously generates the same vibration to overlap the vibrations. Thus, even if the energy of the generated vibration is small, the vibration can reach a distant place. The seismic source portion 130 is capable of transmitting vibrations up to a distance of 1 km even when the weight of the counterweight is about 10 g.

The rotation speed of the rotation shaft 164 is not particularly limited, and may be, for example, a speed at which vibration of about 20 Hz to 60 Hz is generated. In general, the higher the frequency of vibration, the higher the resolution of the seismic exploration, and the lower the frequency of vibration, the less the vibration is attenuated, and the vibration can be transmitted to a far place. It is preferable that the vibration has a wide frequency range.

Various parts of the seismic source portion 130 described above can be appropriately replaced in order to adjust vibration conditions. For example, the weights of the counterweights 179 and 188 may be changed according to the monitoring target in the seismic exploration to adjust the vibration conditions. For example, in a case where the monitoring target is a dam, the weights of the counterweights 179 and 188 may be set to about 10 g. When the monitoring target is wide or deep, the weights of the counterweights may be set to about 100 g.

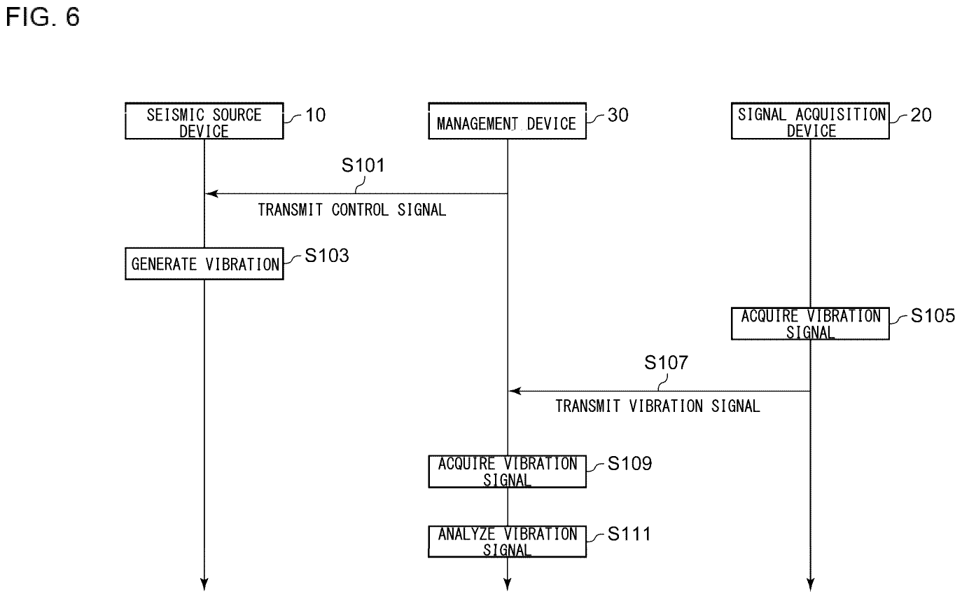

FIG. 6 is a flowchart illustrating an operation example of the seismic exploration system 1 according to the first embodiment. Hereinafter, the operation example of the seismic exploration system 1 will be described with reference to the flowchart.

First, the management device 30 transmits a control signal to the seismic source device 10 (S101). Next, the seismic source device 10 generates vibration based on the control signal transmitted in S101 (S103: vibration generation step). Next, the signal acquisition device 20 acquires a vibration signal based on the vibration generated in S103 (S105: signal acquisition step). Next, the signal acquisition device 20 transmits the vibration signal acquired in S105 to the management device 30 (S107). Next, the management device 30 acquires the vibration signal (S109), and analyzes the vibration signal (S111).

Note that the processing of each step illustrated in the flowchart of FIG. 6 is not necessarily performed in the order illustrated in FIG. 6. The order of each step may be rearranged, or a plurality of steps may be processed in parallel within a range in which there is no logical contradiction. Further, by repeatedly and continuously performing the processing of S101 to S109, the S/N ratio of the vibration signal can be increased.

### Effects of Present Embodiment

Conventionally, seismic source devices installed on the ground surface have been developed. However, influences near the ground surface such as rainfall and ice and snow strongly affect the results of monitoring in the seismic exploration. In particular, the influence of the ground surface environment occurs when the exploration of the geological structure is repeatedly performed via seismic exploration and the monitoring of capturing the minute change is performed. For this reason, the seismic exploration using a conventional seismic source device is easily affected by the ground surface, and thus, it is difficult to monitor the geological change.

According to the seismic exploration system 1 of the present embodiment, the management device 30 can perform the seismic exploration using the vibration signal based on the vibration generated from the seismic source device 10 disposed in the subsurface. Therefore, according to the seismic exploration system 1 of the present embodiment, it is possible to suppress the influence of the environment on the ground surface as compared with the case of monitoring using the vibration of the seismic source device installed on the ground surface, and thus, it is possible to perform monitoring with higher accuracy.

In addition, according to the seismic exploration system 1 of the present embodiment, the target to be monitored is in the subsurface, and thus, vibration can be generated at a position closer to the target. Therefore, according to the seismic exploration system 1 of the present embodiment, it is possible to monitor the subsurface via seismic exploration with higher accuracy.

In addition, according to the seismic exploration system 1 of the present embodiment, it is possible to perform monitoring in consideration of the environment. Specifically, according to the seismic exploration system 1 of the present embodiment, vibration is generated in the subsurface, and thus, noise due to vibration can be reduced as compared with a case where vibration is generated on the ground surface. Therefore, the seismic exploration system 1 according to the present embodiment can be used even in an urban area or at night.

A conventional seismic source device (for example, a vibroseis) used in seismic exploration is huge, and is difficult to operate in a place with poor access, and its cost is high. On the other hand, according to the seismic exploration system 1 of the present embodiment, the vibration can be generated even in a limited place where the access is poor by using the seismic source unit 12 which is small. Therefore, according to the seismic exploration system 1 of the present embodiment, it is possible to perform the seismic exploration at a lower cost in more various places. For example, a large number of CO2 storage sites can be simultaneously monitored by digging a large number of holes, disposing the seismic source unit 12 according to the present embodiment in each hole, and analyzing vibration signals based on vibrations generated by these seismic source units 12.

In addition, the conventional seismic source device is not designed for constant installation and cannot be continuously used for monitoring the subsurface. In the seismic exploration using the conventional seismic source device, for example, monitoring is generally performed once in several years. On the other hand, according to the seismic exploration system 1 of the present embodiment, the seismic source unit 12 is small, enabling permanent installation. In addition, since the seismic source unit 12 has a mechanism capable of continuously generating vibration, steady and continuous subsurface monitoring can be performed. For example, by constantly monitoring the CO2 storage sites, it is possible to cope with sudden leakage of CO2 and the like.

In addition, conventionally, attempts have been made to dispose a seismic source device using a piezoelectric element in the subsurface to generate vibration. However, when the piezoelectric element is used, the vibration is weak, and thus, it is not possible to realize vibration having sufficient strength for seismic exploration. On the other hand, according to the seismic exploration system 1 of the present embodiment, the eccentric rotating body is rotated, and the coupling between the seismic source unit 12 and the inner peripheral surface 420 of the hole 42 is strengthened by the coupling mechanism 140, and thus, vibration of sufficient strength can be generated to monitor the subsurface via seismic exploration.

In order to install the seismic source device on the lunar surface or the like, the coupling between the seismic source device and the lunar surface is weaker than that on the earth due to the low gravity environment. According to the seismic exploration system 1 of the present embodiment, the seismic source unit 12 is coupled to the hole formed in the subsurface using the coupling mechanism, and thus, stable vibration can be generated while achieving good coupling even with low gravity.

The seismic exploration system 1 according to the present embodiment can also be used for monitoring in subsurface reservoirs beneath the sea floor. Since the sea floor surface is soft, even if the seismic source device is disposed on the sea floor surface to generate vibration, the vibration is greatly attenuated, and it is difficult to perform good seismic exploration. On the other hand, in the deep part of the sea floor, the rock is harder than the sea floor surface. Therefore, according to the seismic exploration system 1 of the present embodiment, a hole is made in the sea floor, and the seismic source device is inserted in the subsurface and fixed to hard rock there, so that it is possible to suppress the attenuation of vibration and perform accurate subsurface monitoring even in the sea floor.

In addition, the seismic exploration system 1 according to the present embodiment can be used for various applications including the above-described examples. For example, the seismic exploration system 1 can be used for resource energy and decarbonization fields such as monitoring of a storage CO2 distribution and an induced earthquake at a CO2 subsurface storage site, monitoring of a subsurface reservoir for carbon neutral such as CO2 subsurface storage and hydrogen subsurface storage, monitoring of a geothermal subsurface reservoir, monitoring of groundwater, and monitoring of a subsurface reservoir of resources in oil gas development, civil engineering fields such as health monitoring of civil engineering buildings such as embankments, tunnels, and dams, subsurface imaging in extraterrestrial space such as the lunar surface and the Mars, and in difficult-to-access regions such as mountainous areas, and the like.

### Second Embodiment

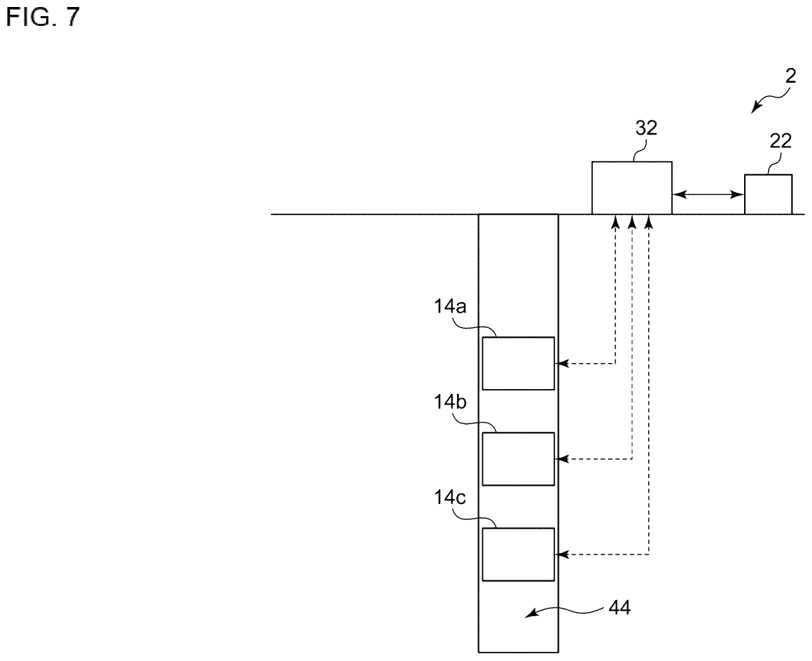

FIG. 7 is a diagram illustrating a schematic configuration of a seismic exploration system 2 according to a second embodiment and a subsurface cross section thereof. The seismic exploration system 2 according to the second embodiment includes three seismic source units 14a to 14c, a geophone 22 (second geophone), and a management device 32. The geophone 22 and the management device 32 may have substantially the same configuration as the geophone 20b and the management device 30 described in the first embodiment, respectively.

Each of the seismic source units 14a to 14c may have substantially the same configuration as the seismic source unit 12 described in the first embodiment and can generate vibration. The seismic source units 14a to 14c according to the second embodiment are disposed in one hole 44, and more specifically, are disposed in a direction in which the hole 44 extends (that is, the vertical direction). Although three seismic source units are illustrated in FIG. 7, two seismic source units may be disposed, or four or more seismic source units may be disposed.

The vibration signal based on the vibration generated by the seismic source unit 14 is acquired by the geophone (first geophone) included in the seismic source unit 14 and the geophone 22. The management device 32 can perform analysis using the vibration signal. Therefore, the management device 32 can analyze the geology using the vibration signal based on the vibration generated by each of the seismic source units 14a to 14c. Further, by changing and characterizing waveforms of vibrations generated by the plurality of seismic source units 14, even when the plurality of seismic source units 14 oscillate simultaneously, vibrations from the respective seismic source units 14 can be analyzed in a distinguished manner.

By using the plurality of seismic source units 14a to 14c in this manner, more detailed seismic exploration can be performed. Further, by arranging the plurality of seismic source units 14a to 14c in the direction in which the hole 44 extends, it is possible to monitor the subsurface by seismic exploration with a higher spatial resolution.

### Third Embodiment

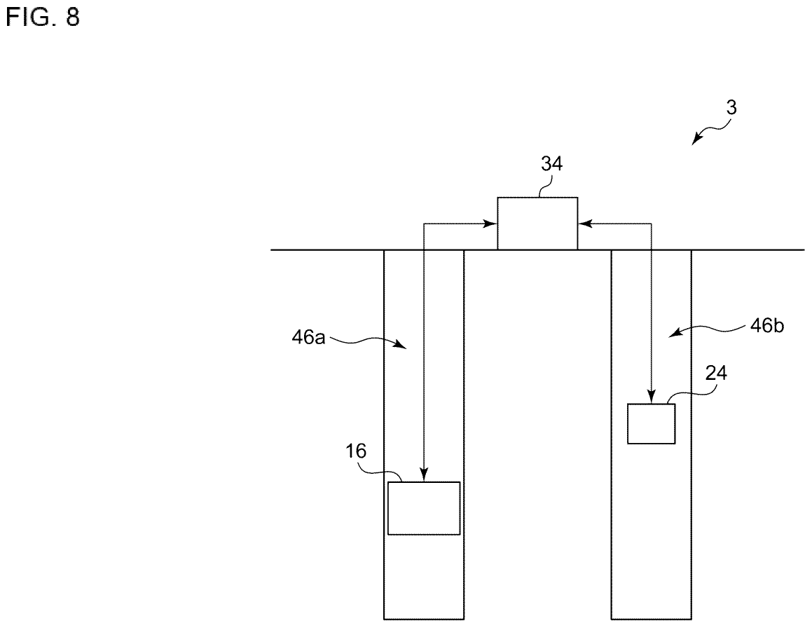

FIG. 8 is a diagram illustrating a schematic configuration of a seismic exploration system 3 according to a third embodiment and a subsurface cross section thereof. The seismic exploration system 3 according to the third embodiment includes a seismic source unit 16, a geophone 24 (second geophone), and a management device 34. The seismic source unit 16, the geophone 24, and the management device 34 may have substantially the same configuration as the seismic source unit 12, the geophone 20b, and the management device 30 described in the first embodiment, respectively.

As illustrated in FIG. 8, in the third embodiment, two holes 46a and 46b extending in the vertical direction are formed in the subsurface. The seismic source unit 16 is disposed in one hole 46a, and the geophone 24 is disposed in the other hole 46b. As described above, in the third embodiment, the geophone 24 is disposed in the subsurface unlike the above embodiment.

A geophone (first geophone) included in the seismic source unit 16 acquires a first vibration signal based on the vibration generated by the seismic source unit 16. The geophone 24 acquires the second vibration signal based on the vibration generated by the seismic source unit 16. The management device 34 receives the vibration signals (the first vibration signal and the second vibration signal) and performs analysis based on the vibration signals. At this time, since the geophone 24 is disposed in the subsurface, the vibration signals acquired by the geophone 24 are hardly affected by the environment on the ground surface. Therefore, according to the seismic exploration system 3 of the present embodiment, it is possible to monitor the change in the subsurface more accurately.

In FIG. 8, only the seismic source unit 16 is illustrated in the hole 46a, and only the geophone 24 is illustrated in the hole 46b. Not limited to this, a geophone and another seismic source unit may be disposed in the hole 46a in addition to the seismic source unit 16, and a seismic source unit and another geophone may be disposed in the hole 46b in addition to the geophone 24. A plurality of seismic source units 16 may be installed in the hole 46a, and a plurality of geophones may be installed in the hole 46b.

### Fourth Embodiment

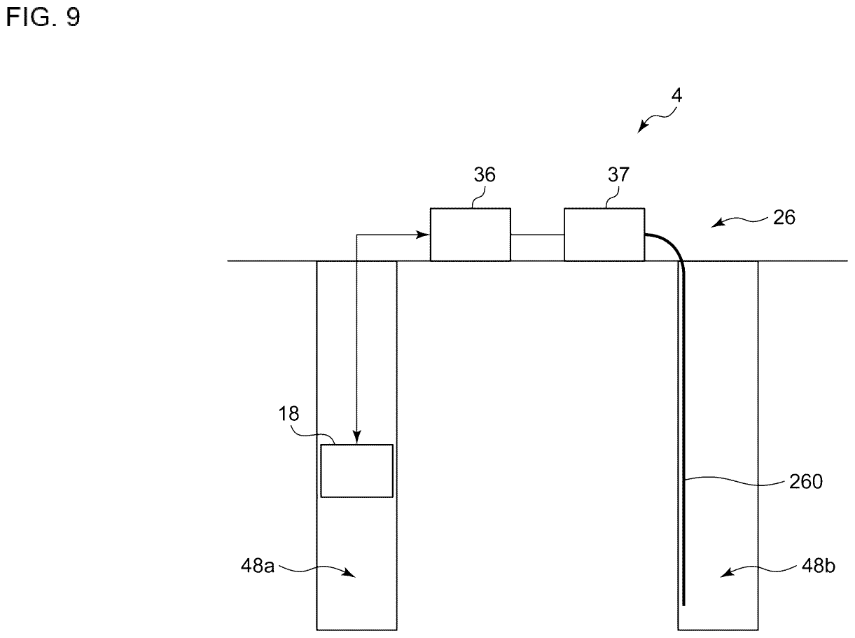

FIG. 9 is a diagram illustrating a schematic configuration of a seismic exploration system 4 according to a fourth embodiment and a subsurface cross section thereof. The seismic exploration system 4 according to the fourth embodiment includes a seismic source unit 18, a signal acquisition device 26, and a management device 36. The seismic source unit 18 may have substantially the same configuration as the seismic source unit 12 according to the first embodiment and may not include the geophone 20a. Furthermore, the management device 36 may have substantially the same configuration as the management device 30 according to the first embodiment.

The signal acquisition device 26 according to the fourth embodiment includes a laser device 37 and an optical fiber 260. The laser device 37 emits laser light to the optical fiber 260, and acquires a vibration signal, which is based on the vibration generated by the seismic source unit 18, on the basis of the laser light reflected by the optical fiber 260. The laser device 37 transmits the acquired vibration signal to the management device 36.

As illustrated in FIG. 9, in the fourth embodiment, two holes 48a and 48b extending in the vertical direction are formed in the subsurface. The seismic source unit 18 is disposed in one hole 48a, and the optical fiber 260 is disposed in the other hole 48b in the direction in which the hole 48b extends.

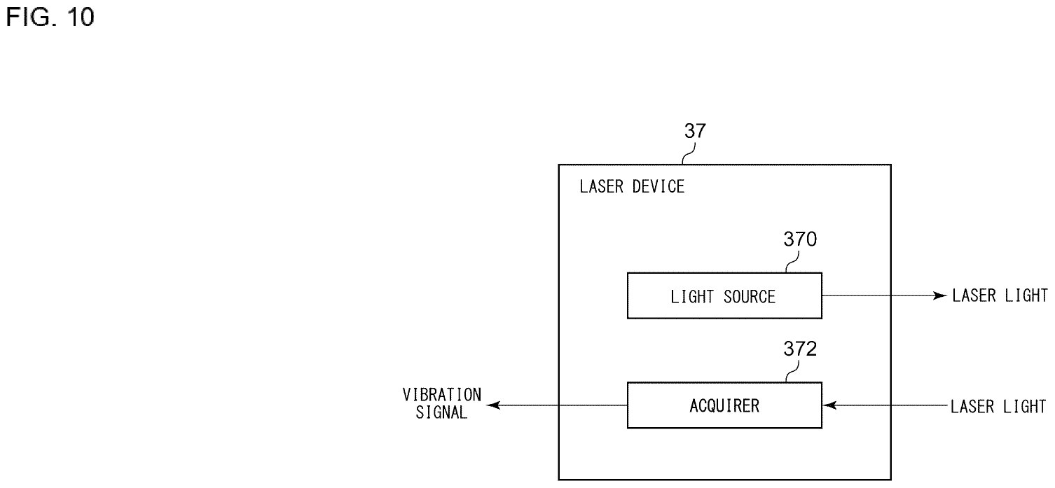

FIG. 10 is a functional block diagram of the laser device 37 according to the fourth embodiment. As illustrated in FIG. 10, the laser device 37 according to the fourth embodiment includes a light source 370 and an acquirer 372.

The light source 370 emits laser light, and may include, for example, various known laser light source devices. In the present embodiment, the light source 370 emits laser light to the optical fiber 260. Thus, the laser light is propagated in the optical fiber 260, and at least a part of the laser light is reflected and returned to the laser device 37.

The acquirer 372 acquires a vibration signal based on the laser light propagated through the optical fiber 260. Specifically, the acquirer 372 includes a light receiver which detects laser light reflected by the optical fiber 260 and returned to the laser device 37. At this time, when the seismic source unit 18 generates vibration, the optical fiber 260 expands and contracts in the length direction according to the vibration. Since the state of the laser light returning to the laser device 37 is changed by the expansion and contraction of the optical fiber 260, the acquirer 372 can acquire the vibration signal based on the vibration generated by the seismic source unit 18 by detecting the optical laser of the optical fiber 260.

According to the seismic exploration system 4 of the present embodiment, the vibration signal can be acquired using the optical fiber 260 disposed in the hole 48b. At this time, by using the optical fiber 260, it is possible to implement a function similar to that in a case where a plurality of seismometers is disposed at regular intervals in the hole 48b. For example, when the length of the optical fiber 260 disposed in the hole 48 is 1000 m, it is possible to acquire a vibration signal equivalent to that in a case where the seismometers are disposed every 10 m. Therefore, according to the seismic exploration system 4 of the present embodiment, it is possible to monitor the subsurface in detail by seismic exploration at a low cost without using a large number of seismometers. Furthermore, since the optical fiber 260 is disposed in the subsurface, it is possible to suppress the influence of the ground surface on the vibration signal.

Although FIG. 9 illustrates an example in which only the optical fiber 260 is disposed in the hole 48b, the seismic source unit may be disposed in the hole 48b. In this case, the vibration signal based on the vibration generated by the seismic source unit disposed in the same hole 48b can be acquired using the optical fiber 260.

### Fifth Embodiment

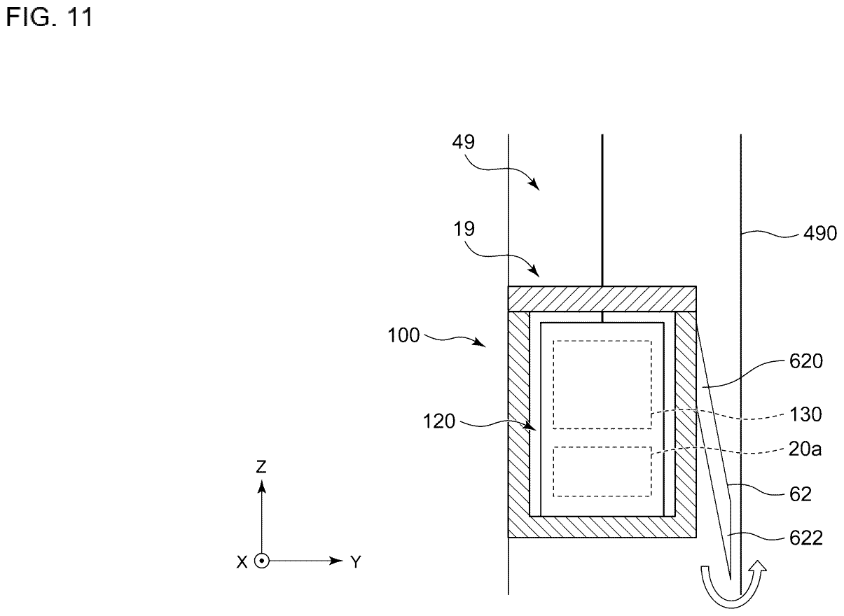

FIG. 11 is a diagram illustrating a schematic configuration of a seismic source unit 19 according to a fifth embodiment. The seismic source unit 19 according to the fifth embodiment is different from the seismic source unit 12 according to the first embodiment mainly in the configuration of the coupling mechanism.

The seismic source unit 19 according to the fifth embodiment includes the housing portion 100, the support 120, the seismic source portion 130, the geophone 20a, and a coupling mechanism 62.

The coupling mechanism 62 according to the fifth embodiment has an arm structure and is connected to the housing portion 100. Specifically, the coupling mechanism 62 extends in a direction away from the housing portion 100, and one end of the coupling mechanism 62 is connected to the housing portion 100 via, for example, a joint portion (not illustrated) structured to be rotatable about an axis (for example, the X axis) parallel to the horizontal plane. Therefore, the coupling mechanism 62 is rotatable about the joint portion. The operation of the coupling mechanism 62 may be electrically controlled, for example, based on control signals from a management device installed on the ground surface.

For example, the coupling mechanism 62 can rotate in the direction of the arrow illustrated in FIG. 11 in a manner that another end 622 of the coupling mechanism 62 approaches an inner peripheral surface 490 of a hole 49. The other end 622 of the coupling mechanism 62 comes into contact with and presses the inner peripheral surface 490 of the hole 49, and thus, the seismic source unit 19 is coupled to the inner peripheral surface 490 of the hole 49. Thus, the vibration generated by the seismic source unit 19 is more reliably transmitted to the periphery of the hole 49 via the side surface of the housing portion 100 or the coupling mechanism 62.

### Sixth Embodiment

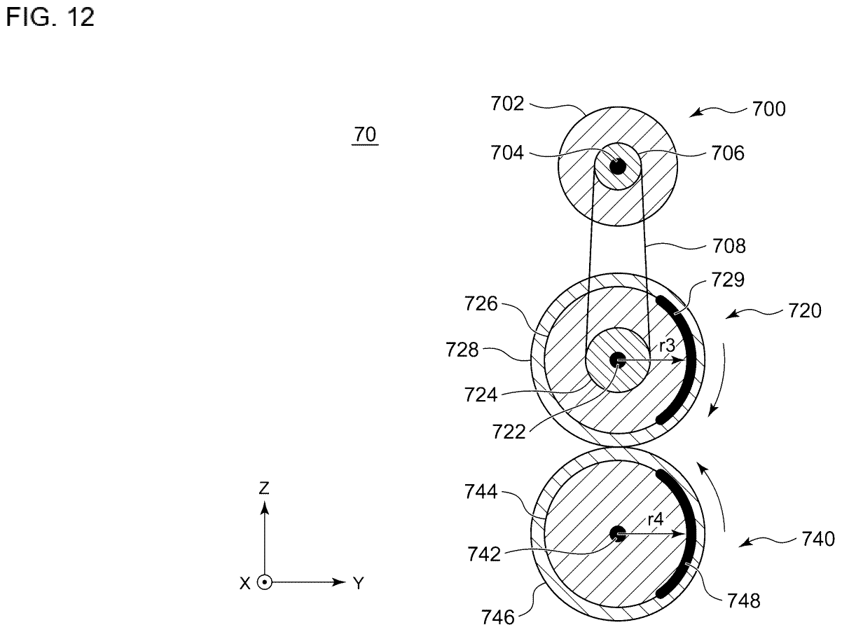

FIG. 12 is a cross-sectional view illustrating a schematic configuration of a seismic source portion 70 according to a sixth embodiment. FIG. 12 illustrates the seismic source portion 70 viewed in the horizontal direction (in FIG. 12, the X-axis direction). As illustrated in FIG. 12, the seismic source portion 70 according to the sixth embodiment includes a motor 700, a first rotating body 720, and a second rotating body 740.

The motor 700 includes a main body 702, a rotation shaft 704, and a transmitter 706. A part of the rotation shaft 704 is housed in the main body 702. The rotation shaft 704 extends in the X-axis direction and is structured to be rotatable about the length direction thereof. The transmitter 706 has a cylindrical shape extending in the X-axis direction, is provided in a manner of covering the rotation shaft 704 and is structured to be rotatable integrally with the rotation shaft 704.

The first rotating body 720 includes a rotation shaft 722, a transmission target 724, a counterweight support 726, a gear 728, and a counterweight 729. The rotation shaft 722 extends in the X-axis direction and is structured to be rotatable about the length direction thereof. The transmission target 724 has a cylindrical shape extending in the X-axis direction, is disposed in a manner of covering the rotation shaft 722 and is structured to be rotatable integrally with the rotation shaft 722. A belt 708 is provided around the transmitter 706 and around the transmission target 724 so that the driving force is transmitted from the transmitter 706 to the transmission target 724.

The disk-shaped counterweight support 726 is provided around the transmission target 724 and is structured to be rotatable integrally with the transmission target 724. The disk-shaped gear 728 is provided around the counterweight support 726 and is structured to be rotatable integrally with the counterweight support 726. The counterweight 729 is provided on a part of the circumference of the counterweight support 726. Due to the counterweight 729, the first rotating body 720 is eccentrically positioned relative to the center thereof (the position of the rotation shaft 722 on the YZ plane) toward the center of the counterweight 729. In the state illustrated in FIG. 12, the first rotating body 720 is eccentrically positioned at a distance of r3 in the Y-axis direction from its center.

The second rotating body 740 includes a rotation shaft 742, a counterweight support 744, a gear 746, and a counterweight 748. The rotation shaft 742 extends in the X-axis direction and is structured to be rotatable about the length direction thereof. The disk-shaped counterweight support 744 is provided around the rotation shaft 742 and is structured to be rotatable integrally with the rotation shaft 742. The disk-shaped gear 746 is provided around the counterweight support 744 and is structured to be rotatable integrally with the counterweight support 744.

The counterweight 748 is provided on a part of the circumference of the counterweight support 744. Due to the counterweight 748, the second rotating body 740 is eccentrically positioned away from the center thereof (the position of the rotation shaft 742 on the YZ plane). In the state illustrated in FIG. 12, the second rotating body 740 is eccentrically positioned at a distance of r4 in the Y-axis direction from its center.

In the present embodiment, the mass of the counterweight 729 and the mass of the counterweight 748 are equal to each other at m2. In addition, the counterweight 729 and the counterweight 748 are disposed on the first rotating body 720 and the second rotating body 740 in a manner that the amounts of eccentricity are equal to each other. Therefore, the counterweight 729 and the counterweight 748 are disposed in a manner that m2×r3=m2×r4.

When the motor 700 is driven, the rotation shaft 704 rotates, and with this rotation, the transmitter 706 rotates together with the rotation shaft 704. At this time, the driving force is transmitted from the transmitter 706 to the transmission target 724 via the belt 708. Thus, the transmission target 724 rotates in the clockwise direction about the rotation shaft 722 together with the other members forming the first rotating body 720. At this time, the gear 746 of the second rotating body 740 receives a driving force from the gear 728 of the first rotating body 720, and the gear 746 rotates around the rotation shaft 742 in a direction opposite to the first rotating body 720 (counterclockwise direction) together with the other members forming the second rotating body 740.

Focusing on the operations of the counterweight 729 and the counterweight 748 during the rotation of the first rotating body 720 and the second rotating body 740, the components in the vertical direction (Z-axis direction) of the rotation speeds of the counterweights 729 and 748 cancel out each other, and the components in the horizontal direction (for example, Y-axis component) of the rotation speeds of the counterweights 729 and 748 intensify each other. Thus, the seismic source portion 70 can generate vibration in the horizontal direction through rotating the first rotating body 720 and the second rotating body 740 by driving the motor 700.

As described above, according to the seismic source portion 70 of the present embodiment, it is possible to generate vibration having a component in one direction on the horizontal plane and use the vibration for seismic exploration.

### Seventh Embodiment

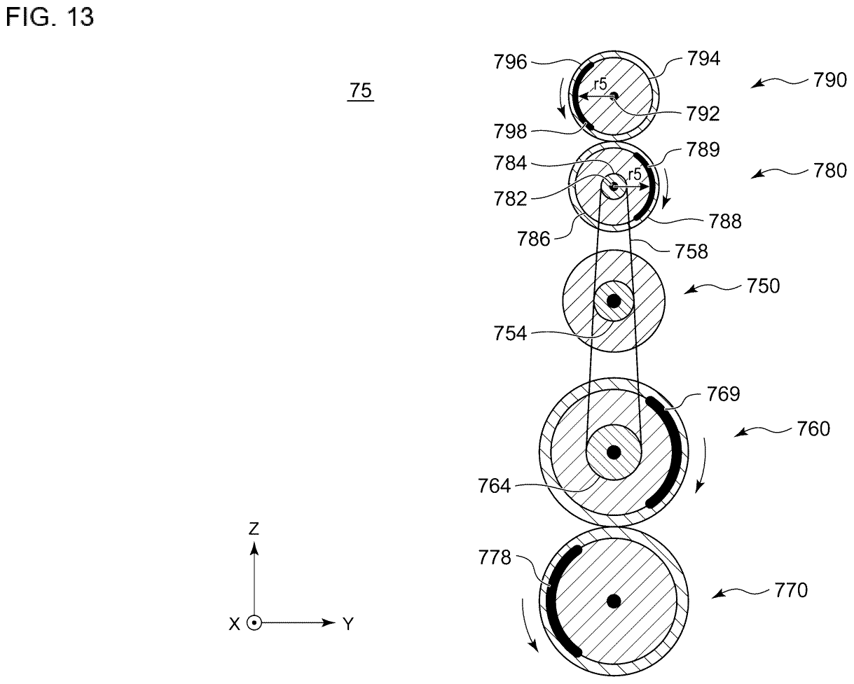

FIG. 13 is a cross-sectional view schematically illustrating a seismic source portion 75 according to a seventh embodiment. The seismic source portion 75 according to the seventh embodiment mainly includes a motor 750, a first rotating body 760, a second rotating body 770, a third rotating body 780, and a fourth rotating body 790. The seismic source portion 75 according to the seventh embodiment is different from the seismic source portion 130 according to the first embodiment mainly in that the seismic source portion 75 includes the third rotating body 780 and the fourth rotating body 790.

The configurations of the motor 750, the first rotating body 760, and the second rotating body 770 according to the seventh embodiment are substantially the same as those of the motor 160, the first rotating body 170, and the second rotating body 180 according to the first embodiment, and thus, detailed description thereof is omitted here.

The third rotating body 780 includes a rotation shaft 782, a transmission target 784, a counterweight support 786, a gear 788, and a counterweight 789. The rotation shaft 782 extends in the X-axis direction and is structured to be rotatable about the length direction thereof. The transmission target 784 has a cylindrical shape extending in the X-axis direction, is disposed in a manner of covering the rotation shaft 782 and is structured to be rotatable integrally with the rotation shaft 782. In the present embodiment, the radius of the transmission target 784 of the third rotating body 780 is smaller than the radius of the transmission target 764 of the first rotating body 760.

In the present embodiment, a belt 758 is provided so that the driving force is transmitted from the transmitter 754 of the motor 750 to the transmission target 784 and the transmission target 764 of the first rotating body 760. Specifically, the belt 758 is provided around the transmission target 784, around the transmitter 754, and around the transmission target 764.

The disk-shaped counterweight support 786 is provided around the transmission target 784 and is structured to be rotatable integrally with the transmission target 784. The disk-shaped gear 788 is provided around the counterweight support 786 and is structured to be rotatable integrally with the counterweight support 786. The counterweight 789 is provided on a part of the circumference of the counterweight support 786. Due to the counterweight 789, the third rotating body 780 is eccentrically positioned relative to the center thereof (the position of the rotation shaft 782 on the YZ plane) toward the center of the counterweight 789. In the state illustrated in FIG. 13, the third rotating body 780 is eccentrically positioned at a distance of r5 in the direction opposite to the Y-axis direction from its center.

The fourth rotating body 790 includes a rotation shaft 792, a counterweight support 794, a gear 796, and a counterweight 798. The rotation shaft 792 extends in the X-axis direction and is structured to be rotatable about the length direction thereof. The disk-shaped counterweight support 794 is provided around the rotation shaft 792 and is structured to be rotatable integrally with the rotation shaft 792. The disk-shaped gear 796 is provided around the counterweight support 794 and is structured to be rotatable integrally with the counterweight support 794.

The counterweight 798 is provided on a part of the circumference of the counterweight support 794. Due to the counterweight 798, the fourth rotating body 790 is eccentrically positioned away from the center thereof (the position of the rotation shaft 792 on the YZ plane). In the state illustrated in FIG. 13, the fourth rotating body 790 is eccentrically positioned at a distance of r5 in the Y-axis direction from its center.

In the present embodiment, the mass of the counterweight 789 and the mass of the counterweight 798 are equal to each other at m3. Note that m3 may be lighter than the counterweight 769 of the first rotating body 760 and the counterweight 778 of the second rotating body 770. In addition, the counterweight 789 and the counterweight 798 are disposed on the third rotating body 780 and the fourth rotating body 790 in a manner that the amounts of eccentricity are equal to each other. Therefore, the counterweight 789 and the counterweight 798 are disposed in a manner that m3×r5=m3×r5.

In the present embodiment, when the motor 750 is driven, the transmitter 754 rotates, and the driving force is transmitted to the transmission target 764 of the first rotating body 760 and the transmission target 784 of the third rotating body 780. At this time, the first rotating body 760 and the second rotating body 770 generate vibration in the vertical direction similarly to the first embodiment.

The transmission target 784 of the third rotating body 780 receives the driving force of the motor 750 and rotates in the clockwise direction about the rotation shaft 782 together with the other members forming the third rotating body 780. At this time, the gear 796 of the fourth rotating body 790 receives a driving force from the gear 788 of the third rotating body 780, and the gear 796 rotates around the rotation shaft 792 in a direction opposite to the third rotating body 780 (counterclockwise direction) together with the other members forming the fourth rotating body 790. At this time, since the counterweights 789 and 798 cancel out the horizontal components of their rotational speeds, the third rotating body 780 and the fourth rotating body 790 generate vibrations in the vertical direction.

The transmission target 784 of the third rotating body 780 receives the driving force of the motor 750 and rotates about the rotation shaft 782. At this time, since the radius of the transmission target 784 is smaller than the radius of the transmission target 764, the transmission target 784 rotates faster than the transmission target 764. Thus, the set of the third rotating body 780 and the fourth rotating body 790 (hereinafter also referred to as “second set”) generates vibration of a higher frequency than the set of the first rotating body 760 and the second rotating body 770 (hereinafter also referred to as “first set”).

As described above, according to the seismic source portion 75 of the present embodiment, by rotating the first set and the second set via the transmission target 764 and the transmission target 784 having different radii, vibrations having different frequencies can be generated. This makes it possible to generate vibrations of a wider frequency range. Thus, the seismic source exploration system can generate vibration more suitable for the target.

In addition, in a case where the second set generates vibration having a higher frequency than the first set as in the present embodiment, it is desirable that the counterweight of the second set is lighter than the counterweight of the first set in order to generate equivalent vibration energy in a wide frequency range.

### Eighth Embodiment

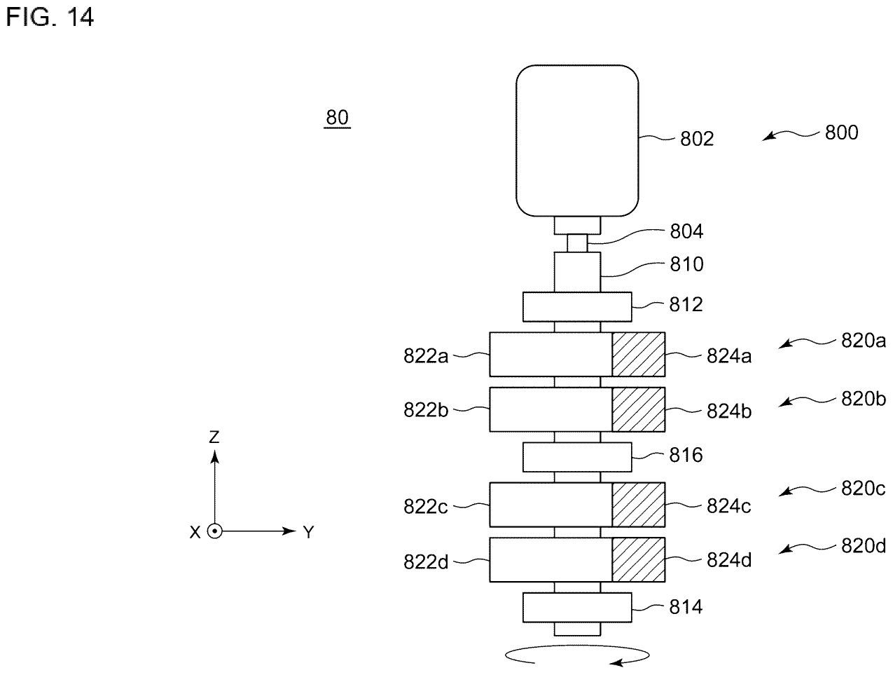

FIG. 14 is a view schematically illustrating a seismic source portion 80 according to an eighth embodiment. FIG. 14 illustrates the seismic source portion 80 viewed in the horizontal direction (in FIG. 14, the X-axis direction). As illustrated in FIG. 14, the seismic source portion 80 according to the eighth embodiment mainly includes a motor 800, a transmitter 810, a first rotating body 820a, a second rotating body 820b, a third rotating body 820c, a fourth rotating body 820d, and bearings 812, 814, and 816.

The motor 800 includes a main body 802 and a rotation shaft 804. A part of the rotation shaft 804 is housed in the main body 802, extends in the Z-axis direction, and is structured to be rotatable about the length direction thereof.

The transmitter 810 has a cylindrical shape extending in the Z-axis direction and is provided on the side of the rotation shaft 804 opposite to the main body 802 in a manner of being rotatable integrally with the rotation shaft 804.

The first rotating body 820a, the second rotating body 820b, the third rotating body 820c, and the fourth rotating body 820d are provided to be rotatable integrally with the transmitter 810 around the transmitter 810 in this order from the side closer to the motor 800. The first rotating body 820a, the second rotating body 820b, the third rotating body 820c, and the fourth rotating body 820d all have substantially the same configuration.

The bearing 812 is provided around the transmitter 810 in a manner of rotatably supporting the transmitter 810 on the motor 800 side relative to the first rotating body 820a. The bearing 814 is provided around the transmitter 810 in a manner of rotatably supporting the transmitter 810 on the side opposite to the motor 800 relative to the fourth rotating body 820d. Further, the bearing 816 rotatably supports the transmitter 810 around the transmitter 810 between the second rotating body 820b and the third rotating body 820c. Although three bearings are illustrated in FIG. 14, the number of bearings may be 2 or less, or 4 or more. As the number of bearings increases, for example, the rotation of the first to fourth rotating bodies 820a to 820d is stabilized, and further, wear of the bearings is reduced, which is advantageous for long-term operation.

The first rotating body 820a has a counterweight support 822a and a counterweight 824a, the second rotating body 820b has a counterweight support 822b and a counterweight 824b, the third rotating body 820c has a counterweight support 822c and a counterweight 824c, and the fourth rotating body 820d has a counterweight support 822d and a counterweight 824d. A counterweight support 822 has a disk shape and is provided around the transmitter 810. Further, a counterweight 824 is provided on a part of the circumference of the counterweight support 822. In the present embodiment, when viewed in the Z-axis direction, all the counterweights 824a to 824d are disposed at the same position, and the positional relationship thereof does not change even when the counterweight support 822 rotates.

When the motor 800 is driven, the rotation shaft 804 rotates. As the rotation shaft 804 rotates, the transmitter 810 rotates about the rotation shaft 804 in a direction indicated by an arrow in FIG. 14. With this rotation, the first rotating body 820a, the second rotating body 820b, the third rotating body 820c, and the fourth rotating body 820d rotate about the rotation shaft 804. At this time, all the counterweights 824a to 824d rotate in the same phase. Therefore, the forces generated by the rotation of the counterweights 824a to 824d intensify each other. Therefore, according to the seismic source portion 80 of the present embodiment, it is possible to generate vibration caused by rotation in a horizontal plane.

The vibration generated by the seismic source portion 80 according to the eighth embodiment has two horizontal components orthogonal to each other, unlike the seismic source portion 70 according to the sixth embodiment. Therefore, the seismic source unit according to the eighth embodiment may include two geophones disposed to be orthogonal to each other so that two horizontal components of vibration can be detected.

According to the above embodiment, the seismic source portion 130 according to the first embodiment can generate vibration in the vertical direction, the seismic source portion 70 according to the sixth embodiment can generate vibration in one direction on the horizontal plane, and the seismic source portion 80 according to the eighth embodiment can generate vibration in a direction of rotating in the horizontal plane. Therefore, by taking out the seismic source unit to the ground surface as necessary and changing the configuration of the seismic source portion, the direction of the component of the vibration to be generated can be changed to a desired condition.

### Ninth Embodiment

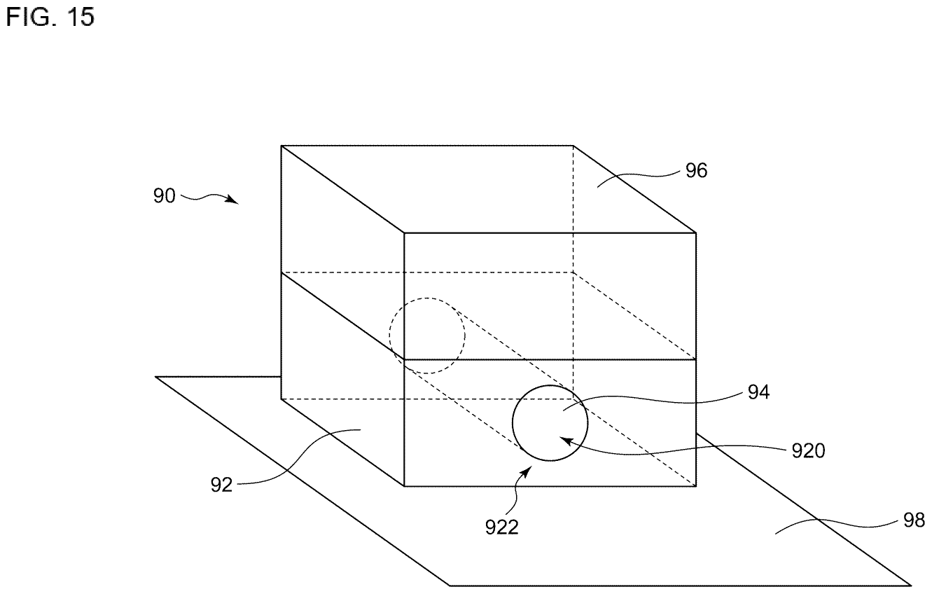

FIG. 15 is a perspective view of a seismic source unit 90 according to a ninth embodiment. The seismic source unit 90 according to the present embodiment is disposed on a ground surface 98. The seismic source unit 90 according to the ninth embodiment includes a housing portion 92 (coupler), a seismic source device 94, and a counterweight 96.

The housing portion 92 has an internal space which is formed of a cylindrical hole 920 and includes an opening 922, and the seismic source device 94 is disposed in the internal space of the housing portion 92. The housing portion 92 may be made of, for example, concrete. The counterweight 96 for coupling the housing portion 92 to the ground surface 98 is disposed on the upper surface of the housing portion 92. The housing portion 92 is pressed against the ground surface 98 by the weight of the counterweight 96, and thereby, the housing portion 92 is coupled to the ground surface 98. Thus, the vibration generated by the seismic source device 94 is more easily transmitted to the ground surface. When the vibration of the seismic source device is large, the counterweight 96 may be increased.

The seismic source device 94 may include the seismic source portion described in the above embodiment. In this case, the direction corresponding to the Z axis is the horizontal direction. Therefore, when the seismic source portion 130 of the first embodiment illustrated in FIG. 5 is used, vibration can be generated in the horizontal direction. When the seismic source portion 70 according to the sixth embodiment illustrated in FIG. 12 is disposed in a manner that the direction corresponding to the Y-axis direction is the vertical direction, vibration can be generated in the vertical direction. Since the seismic source device 94 is disposed in the internal space in a manner of being detachable from the opening 922 of the internal space, the seismic source device 94 can be removed from the housing portion 92 as necessary. Thus, by changing the member (for example, gear, motor, counterweight, etc.) of the seismic source portion and housing the seismic source device in the housing portion 92 again, the seismic exploration can be performed using the vibration under the new condition.

While the preferred embodiments of the present invention have been described using specific terms, such description is for illustrative purposes only, and it is to be understood that changes and variations may be made without departing from the spirit or scope of the appended claims.

What is claimed is:

1. A seismic exploration method comprising:
causing a seismic source device disposed in a subsurface to generate a vibration; and
acquiring, by a signal acquisition device, a vibration signal based on the vibration generated by the seismic source device, wherein
the seismic source device includes a rotating body which is eccentric and rotates about a rotation shaft, and a drive unit which generates the vibration by rotating the rotating body.

2. The seismic exploration method according to claim 1, wherein
the seismic source device is disposed in a hole formed in the subsurface.

3. The seismic exploration method according to claim 2, wherein
the seismic source device is disposed at a position deeper than an aquifer.

4. The seismic exploration method according to claim 2, wherein
a plurality of the seismic source devices is disposed in the hole, and
the plurality of the seismic source devices is disposed in a direction in which the hole extends.

5. The seismic exploration method according to claim 2, wherein
the seismic source device further includes a housing portion which houses the rotating body and the drive unit, and a coupling mechanism which couples the housing portion with an inner surface of the hole.

6. The seismic exploration method according to claim 2, wherein
the signal acquisition device includes a geophone which acquires the vibration signal, and
when the hole in which the seismic source device is disposed is a first hole, the geophone is disposed in a second hole different from the first hole formed in the subsurface.

7. The seismic exploration method according to claim 2, wherein
the signal acquisition device includes an optical fiber which is disposed in a direction in which the hole extends in the hole, a light source which causes a laser light to be propagated through the optical fiber, and an acquirer which acquires the vibration signal based on the laser light propagated.

8. The seismic exploration method according to claim 1, wherein
the rotation shaft is parallel to a horizontal direction.

9. A subsurface monitoring method comprising the seismic exploration method according to claim 1.

10. A seismic exploration system comprising:
a seismic source device that is disposed in a subsurface and generates a vibration; and
a signal acquisition device that acquires a vibration signal based on the vibration generated by the seismic source device, wherein
the seismic source device includes a rotating body which is eccentric and rotates about a rotation shaft, and a drive unit which generates the vibration by rotating the rotating body.

11. A seismic source device comprising:
a seismic source portion that includes a rotating body which is eccentric and rotates about a rotation shaft, and a drive unit which generates a vibration by rotating the rotating body; and
a housing portion that houses the seismic source portion in an internal space, wherein
the housing portion houses the seismic source portion in a manner that the seismic source portion can be detached through an opening of the internal space.

12. The seismic source device according to claim 11, wherein
the seismic source device is disposed in a subsurface, and
the rotation shaft is parallel to a horizontal direction.

13. The seismic source device according to claim 11, wherein
when the rotating body is a first rotating body and the rotation shaft is a first rotation shaft, the seismic source portion further includes a second rotating body which is eccentric and rotates about a second rotation shaft, and
the drive unit rotate each of the first rotating body and the second rotating body such that the first rotating body and the second rotating body generate vibrations having different frequencies.

14. The seismic source device according to claim 11, wherein
the seismic source device is disposed in a hole formed in a subsurface, and the seismic source device further includes a coupling mechanism which couples an inner surface of the hole and the housing portion.

15. The seismic source device according to claim 11,
wherein
the housing portion includes a pressure-resistant container.
